(19) United States
(12) Patent Application Publication
(10) Pub. No.: US 2021/0347658 A1
(43) Pub. Date: Nov. 11, 2021

(54) NOVEL CONDUCTIVE MEMBRANE FILTRATION SYSTEM FOR DEGRADATION OF ORGANIC POLLUTANTS FROM WASTEWATER

(71) Applicant: SHAN DONG UNIVERSITY, Jinan (CN)

(72) Inventors: Xuefei SUN, Jinan (CN); Jing GUAN, Jinan (CN); Shuguang WANG, Jinan (CN)

(21) Appl. No.: 17/277,740

(22) PCT Filed: Feb. 20, 2020
(86) PCT No.: PCT/CN2020/075992

§ 371 Date: Mar. 19, 2021

(30) Foreign Application Priority Data
Jul. 12, 2019 (CN) 201910628883.3

(51) Int. Cl. C02F 1/469; C02F 1/46; C02F 1/467; C02F 1/461; B01D 69/02; B01D 71/02; B01D 71/34; B01D 67/00; B01D 69/12; B01D 69/10

(52) U.S. Cl. CPC C02F 1/469; C02F 1/4602; C02F 1/4672; C02F 1/46109; B01D 69/02; C02F 2101/308; B01D 71/34; B01D 67/0079; B01D 69/12; B01D 69/105; B01D 71/021

(57) ABSTRACT

This invention relates to a novel conductive organic membrane-coupled filtration system for the degradation of organic pollutants from wastewater. The system comprises a connected water pump and a reactor. The upper end of the reactor contained a water inlet, and the lower end consisted of a water outlet. A counter electrode and a membrane electrode are fixed on the reactor between the water inlet and water outlet. The counter electrode and membrane electrode constitute a two-electrode system connected to an external potentiostat through metal wires. The membrane electrode is made of carbon-based polyvinylidene fluoride (PVDF) membrane that can be used to enhance the electrochemical separation of small molecules and the removal of organic pollutants.

### TECHNICAL FIELD

The present invention relates to a conductive organic membrane-coupled filtration system for the degradation of organic pollutants from wastewater, thereby belonging to the technical field of wastewater treatment and resource utilization.

### BACKGROUND ART

Since the 21st century, water quality and quantity have become survival challenges faced by mankind. The limited sanitation and clean drinking water kill up to 1.6 million people every year worldwide. Membrane filtration is an efficient separation and purification technology often used in the field of wastewater treatment and resource utilization due to its low energy consumption, stable operation, small footprint, and high effluent quality. In this regard, the Chinese patent (CN105060617A) discloses a double membrane internal cycling bio-reactor (DMBR) treatment for low concentration organic wastewater. In this process, the organic wastewater is first subject to slag removal through grille and grid, and then enters in the DMBR to yield even distribution on the packing biofilm reaction zone through the water distribution device. Internal circulation is formed between the packed biofilm reaction zone and micro-filtration membrane filtration zone under the action of airflow. This alternately opens the air inlet electric valves in the packing biofilm reaction zone and micro-filtration membrane filtration zone to form an anaerobic-anoxic-aerobic environment. In turn, this completes the aerobic nitrification and phosphorus absorption, as well as anoxic denitrification and anaerobic phosphorus release of microorganisms. During this process, the falling biofilm and particulate matter are intercepted by the micro-filtration membrane, and clean water is pumped out through the micro-filtration membrane by the self-priming pump followed by disinfection by ultraviolet light to meet the discharge standard. However, particles and other pollutants intercepted by the micro-filtration membrane could easily cause membrane fouling, leading to the poor treatment effect of highly concentrated organic wastewater.

Meanwhile, the membrane fouling caused by the accumulation of macromolecules, colloidal particles, microorganisms, and concentrated wastewater during membrane filtration limits the applications of membrane filtration technology. This can be solved by combining membrane filtration with electrochemical technology to alleviate the membrane pollution problem and degrade concentrated pollutants. This approach gained increasing attention in wastewater treatment fields. The preparation routes of conductive organic membranes currently include conductive modification of substrate membranes and conductive nano-materials loading on membranes. For instance, the Chinese patent (CN104857866A) discloses a method for preparing a hydrophilic modified PVDF membrane. This process consists of preparing a PVDF membrane containing an initiator followed by grafting of KH570 on the PVDF membrane. Next, the grafted PVDF membrane is immersed in TiO₂ solution to yield a hydrophilic modified PVDF membrane. This method is promising but suffers from a few disadvantages, including the complexity of the modification process, poor membrane stability, easy secondary pollution, and high preparation cost. These drawbacks hinder the industrial application of such conductive organic membranes.

### DESCRIPTION OF THE INVENTION

To solve the drawbacks of prior state-of-art methods, the present invention provides a conductive organic membrane-coupled filtration system for the degradation of organic wastewater. This invention combines electrochemistry with membrane filtration technology to realize the degradation of organic matter during wastewater treatment. The proposed method fixes the defects of traditional membrane modification processes and solves issues encountered by membrane pollution technologies.

The proposed invention comprises a conductive organic membrane filtration system consisting of a connected water pump and a reactor. The upper end of the reactor is made of water inlet and the lower end contains a water outlet. A counter electrode and a membrane electrode are fixed on the reactor between the water inlet and the water outlet. The counter electrode and membrane electrode constitute a two-electrode system connected to an external potentiostat through metal wires. The membrane electrode is made of a carbon-based PVDF membrane.

In the optimized invention, the metal wire is made of titanium wire. The counter electrode and membrane electrode are respectively embedded in the electrode slot of the reactor then fixed by waterproof glue, Vaseline, and silica gel gasket.

In the optimized invention, the counter electrode is directly located above the membrane electrode. The vertical distance between the membrane electrode and the counter electrode is fixed to 1-3 cm.

In the optimized invention, the counter electrode is made of metals like platinum mesh, titanium mesh, or stainless steel mesh.

In the optimized invention, the potentiostat provides a stable voltage ranging from 0 to 30 V.

In the optimized invention, the membrane electrode is prepared by first coating the PVDF casting solution on pretreated dry carbon fiber by scraping the membrane to yield a coating thickness of 300-400 μm. The modified electrode is then left to stand in air for 1-5 min followed by immersion in deionized water overnight to form the PVDF coating base membrane. The as-obtained membrane is dried in a vacuum to yield a smooth uniform carbon-based polyvinylidene fluoride (CC/PVDF) membrane by phase transformation method. The scraping membrane in the proposed invention can be prepared by conventional technology.

In the optimized invention, the carbon fiber is made of polyacrylonitrile-based carbon fiber, which is pretreated by ultrasounds in acetone, ethanol, and deionized water solution for 60-80 min to remove any organic matters and other impurities attached to the carbon fiber. The resulting carbon fiber is then dried at 50-80° C. for 4-5 hours.

In the optimized invention, the PVDF casting solution is prepared by first dissolving PVDF powder and porogen polyvinylpyrrolidone (PVP) in N, N-dimethylformamide (DMF) under magnetic stirring for 10-12 hours. The resulting suspension is then vacuum degassed at 50-80° C. for 3-5 hours to yield a PVDF casting solution. Wherein, the mass ratio of PVDF powder to PVP and DMF is 12:2:86.

In the optimized invention, the vacuum drying conditions are set to 50-80° C. and 50-70 min.

In the optimized invention, the phase conversion method consists of PVDF casting solution applied on the PVDF coating membrane. This is achieved by scraping the membrane followed by fixing the base membrane on the glass plate to form a coating thickness of 200-400 μm. Next, the glass plate is slowly immersed in 25-28° C. constant temperature deionized water after standing in the air for 1-3 min to form a three-dimensional macromolecular network gel structure membrane after phase transformation.

Note that phase transformation refers to mass transfer between the PVDF casting solution and deionized water through the solvent and non-solvent two-phase interface.

In the proposed invention, the degradation of organic by the conductive organic membrane-coupled filtration system consists first of pretreating the reactor by passing pure water for 20-30 minutes to stabilize the membrane electrode. Afterward, the potentiostat is used to apply a stable voltage through the counter and membrane electrodes. During this process, the organic wastewater is continuously pumped into the reactor to be treated, and the purified wastewater flows out from the outlet fixed between the counter and membrane electrodes.

In the optimized invention, the organic wastewater passes through the counter electrode and membrane electrode at a flow rate of 3^{˜}5 mL/min.

In the optimized invention, the organic wastewater is composed of water containing methyl orange or humic acid.

The filtration of organic wastewater consists of using electrostatic repulsion, electrically enhanced wetting, direct electron transfer, and hydroxyl radical advanced oxidation during the passage of the organic wastewater through the reactor.

Electrostatic repulsion refers to the application of a negative potential to the membrane electrode in the conductive organic membrane coupled filtration system. During this process, the pollutants become negatively charged due to electrostatic repulsion. Pollutants with the same charge as the membrane electrode will be repulsed away. This declines the deposition of pollutants on the membrane, thereby alleviating membrane fouling.

Electrically enhanced wetting refers to the application of voltage to the membrane electrode by connecting the external potential of the solid-liquid interface to reduce the interfacial tension of the solid-liquid surface without changes in the chemical composition of the membrane surface. This process decreases the water contact angle of the membrane surface, thereby improving the wettability and water flux of the membrane.

Direct electron transfer and hydroxyl radical advanced oxidation refer to the occurrence of direct electron transfer in the membrane electrode under an applied potential to the membrane greater than the oxidation potential of the organic matter after entering the system. This process promotes the redox reactions of organic wastewater for efficient degradation of organic wastewater. Under polarization of the membrane, the dissolved oxygen generates hydrogen peroxide through the double electron reduction of oxygen. The catalytic action of active sites on carbon fiber or titanium dioxide present on the counter electrode surface incites a Fenton-like reaction to produce hydroxyl radicals. These species can also be produced by direct oxidation of water, further oxidizing and even mineralizing pollutants.

The technical characteristics and beneficial effects of the proposed invention can be summarized as follows:

1. The CC/PVDF conductive organic membrane is prepared by a two-step phase conversion. This method requires a coating of the carbon fiber with PVDF casting solution twice. The first round of scraping and coating PVDF casting solution improves the rough fabric structure of the carbon fiber. The mechanical stability of the membrane can also be improved by combining the casting solution and pore wall on the carbon fiber. The second round consists of preparing a smooth and dense membrane selective layer. The CC/PVDF membrane with excellent conductivity, good mechanical stability, and smooth/uniform surface morphology. These features overcome the shortcomings of traditional conductive membranes, such as complex modification processing, poor membrane stability, high preparation cost, and easy secondary contamination. The carbon-based PVDF membrane prepared by the proposed invention can be coupled with electrochemistry to enhance the separation ability of small molecular substances. It can also overcome the limitation of membrane pore interception of traditional membrane filtration processes, leading to the removal of pollutants smaller than the membrane pores and strengthening the removal of pollutants. Meanwhile, the carbon-based PVDF membrane is characterized by high efficiency and economy, thereby advantageous as a conductive organic membrane filtration system.

2. In the proposed conductive organic membrane-coupled filtration system, a potential is applied to the two-electrode system by a potentiostat. Electrostatic repulsion, electrically enhanced wetting, direct electron transfer, and hydroxyl radical advanced oxidation take place during the passage of organic wastewater through the counter electrode and membrane electrode. This, in turn, controls the membrane fouling and degradation of organic wastewater to solve problems related to concentrated solutions encountered in traditional membrane filtration processes. This can also fix the barrier in the membrane application.

3. The proposed conductive organic membrane-coupled filtration system is advantageous in terms of low energy consumption, simple processing, stable operation, high effluent quality, small floor area and easy automatic control, thereby promising for broad applications.

### DESCRIPTION OF THE DRAWINGS

FIG. 1 shows a schematic diagram of the conductive organic membrane-coupled filtration system in Embodiment 1. The different components can be described as: (1) Water pump, (2) Water inlet, (3) Counter electrode, (4) Membrane electrode, (5) Water outlet, (6) Potentiostat, and (7) Reactor.

FIG. 2 displays scanning electron microscopy (SEM) images of the carbon fiber, basement membrane, and CC/PVDF membrane in Embodiment 1.

FIG. 3 illustrates a confocal laser scanning microscopy (CLSM) image of the carbon fiber in Embodiment 1.

FIG. 4 represents a CLSM image of the basement membrane in Embodiment 1.

FIG. 5 refers to a CLSM image of the CC/PVDF membrane in Embodiment 1.

FIG. 6 exhibits a SEM image of the CC/PVDF membrane in Embodiment 2 after the passage of organic wastewater through the system for 30 min.

FIG. 7 displays a ATR-FTIR spectrometry image of the CC/PVDF membrane in Embodiment 2 after the passage of organic wastewater through the system for 30 min.

FIG. 8 shows the voltage-current curves of methyl orange solutions at different concentrations passing through CC/PVDF membrane in Embodiment 2.

FIG. 9 illustrates a SEM image of the CC/PVDF membrane under 0 V voltage in Embodiment 4 after the passage of organic wastewater through the system for 30 min.

FIG. 10 is a SEM image of the CC/PVDF membrane under applied 1 V in Embodiment 4 after the passage of organic wastewater through the system for 30 min.

FIG. 11 presents a SEM image of the CC/PVDF membrane under an applied 2 V voltage in Embodiment 4 after passing the organic wastewater through the system for 30 min.

FIG. 12 shows a SEM image of the CC/PVDF membrane under an applied 3 V voltage in Embodiment 4 after passing organic wastewater through the system for 30 min.

### DESCRIPTION OF EMBODIMENTS OF THE INVENTION

The proposed invention is described in combination with the drawings and specific embodiments, but the protection scope of the invention is not limited to the described.

Meanwhile, the experimental methods described in the following embodiments are conventional without special instructions. The reagents, materials, and equipment can be obtained from commercial providers without special instructions.

In the embodiment, the electrochemical equipment is a CH11030C multi-channel potentiostat sold by Shanghai Chenhua Instrument Co., Ltd. The titanium 60 mesh is sold by Cangzhou Kangwei metal products Co., Ltd. The carbon fiber is made of polyacrylonitrile commercialized by Shanghai Hesen Electric Co., Ltd. The conductive adhesive, titanium wire, waterproof adhesive, Vaseline, silica gel gasket, PVDF, methyl orange, and humic acid are all commercial products.

### Embodiment 1

As shown in FIG. 1, the conductive organic membrane coupled-filtration system consists of a water pump 1 and a reactor 7 made of a closed plexiglass column with an effective volume of 12 L. Water inlet 2 is arranged at the upper end of reactor 7, and water outlet 5 is arranged at the lower end. Water inlet 2 is connected to water pump 1. Also, counter electrode 3 and membrane electrode 4 are embedded in reactor 7 between the water inlet 2 and water outlet 5. Counter electrode 3 is made of a 60 mesh titanium mesh, and membrane electrode 4 is composed of a carbon-based PVDF membrane (CC/PVDF membrane). Counter electrode 3 is located above membrane electrode 4 at a vertical distance of 1 cm. The interception of the membrane electrode 4 accumulates the pollutants in the organic wastewater between the two electrodes, leading to their degradation to a greater extent due to prolonged redox reactions by increasing the residence time. The membrane electrode 4 and counter electrode 3 constitute two-electrode systems, connected to the external potentiostat 6 through the conductive adhesive and titanium wire.

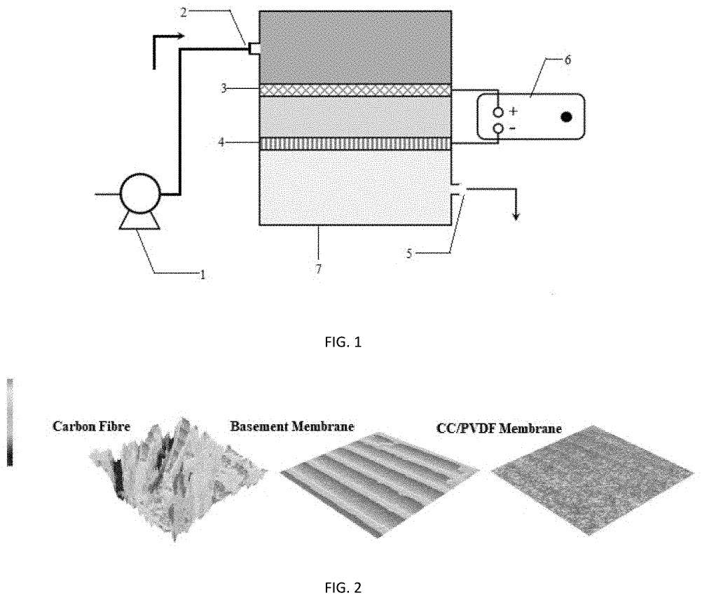

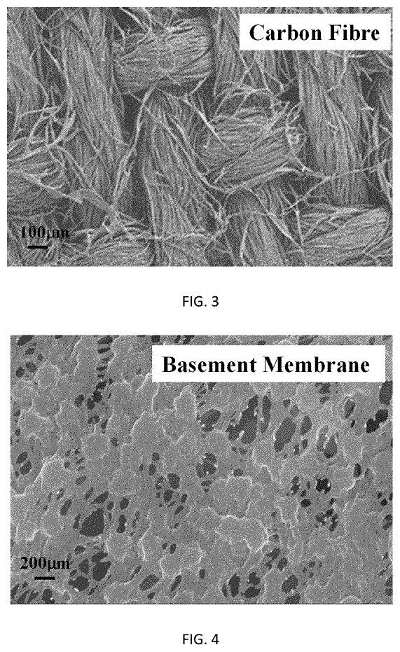

Membrane electrode 4 is made of carbon-based PVDF membrane prepared by first dissolving PVDF powder and PVP in DMF under magnetic stirring for 12 hours. After complete dissolution, the PVDF casting solution is prepared after vacuum degassing at 50° C. for 4 hours. Next, the PVDF casting solution is coated on the surface of pretreated dried carbon fiber through scraping to form a coating thickness of 300 μm. The modified substrate is then left to stand in the air for 3 min followed by immersion in deionized water overnight to form the PVDF coating base membrane. Afterward, the membrane is vacuum dried at 80° C. for 70 minutes, and then fixed on the glass plate for coating with the PVDF casting solution twice to yield a thickness of 200 μm. The glass plate modified membrane is left to stand in the air for 2 minutes and then slowly immersed in 25° C. constant temperature deionized water to form a smooth and uniform CC/PVDF membrane by phase transformation. As shown in FIG. 2-5, the smooth surface morphology of carbon fiber, basement membrane and CC/PVDF membrane gradually increases, while surface roughness decreases significantly. These features would improve the mechanical stability of CC/PVDF membrane.

The mass ratio of PVDF powder to those of PVP and DMF is 12:2:86.

### Embodiment 2

The degradation of organic wastewater in Embodiment 1 comprises the following steps:

Reactor 7 is pretreated by passing pure water through the system for 20 min to stabilize the membrane electrode. The potentiostat 6 is then turned on and stable voltages of 1 V, 2 V, and 3 V are subsequently applied to the titanium mesh and CC/PVDF membrane. Afterward, the organic wastewater is continuously pumped into reactor 7 and passed through the titanium mesh and CC/PVDF membrane at a flow rate of 4 mL/min to flow out purified wastewater at the outlet.

In this invention, water containing 10 mg/L methyl orange and 10 mm NaCl aqueous solution is used as organic wastewater.

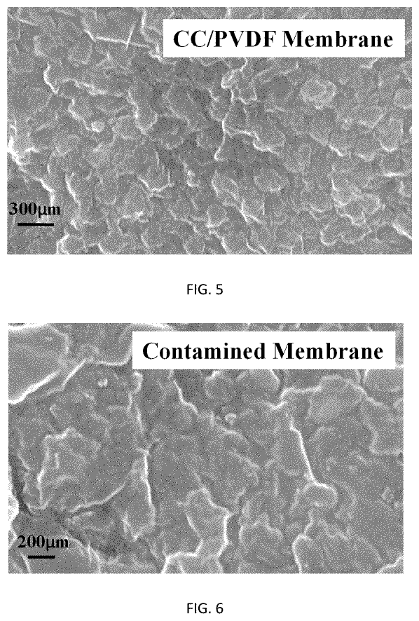

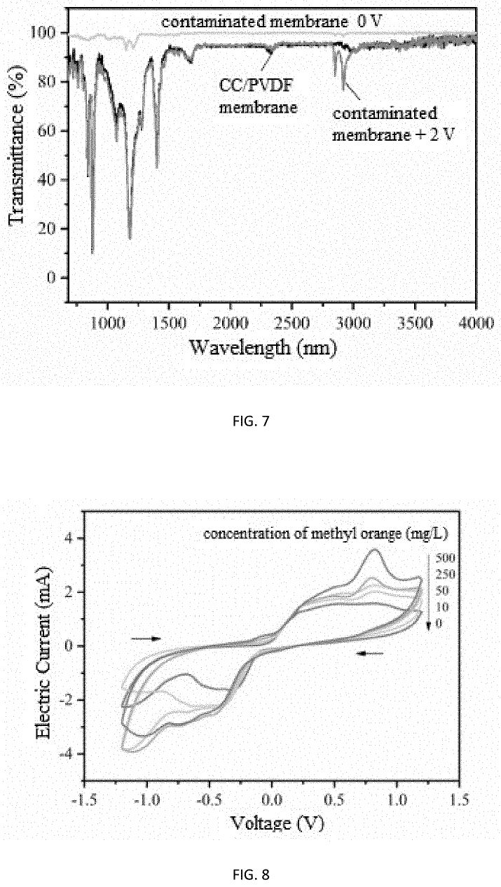

To evaluate the quality of organic wastewater after 30 min operation in this embodiment, the removal efficiency of organic wastewater is tested under stable voltages of 1 V, 2 V, and 3 V. The removal rates of methyl orange are estimated to 21%, 88% and 92%, and membrane water fluxes are 70%, 86% and 92%, respectively. As shown in FIG. 6 and FIG. 7, no obvious differences in surface morphologies and chemical compositions are noticed between the CC/PVDF membrane that passes through the organic wastewater for 30 min, as well as CC/PVDF membrane that does not pass through the organic wastewater. Thus, almost no adhesion or degradation of methyl orange occurs on the membrane, effectively inhibiting the membrane fouling. As shown in FIG. 8, the oxidation potential changes during the passage of organic wastewater through the CC/PVDF membrane. Hence, direct electron transfer takes place in the CC/PVDF membrane.

### Embodiment 3

As described in Embodiment 2, the only difference between this Embodiment and the method used for degrading organic wastewater in Embodiment 1 is the concentration of organic wastewater that is set to 20 mg/L humic acid aqueous solution.

The quality of organic wastewater after 30 min operation in this embodiment is tested under stable voltages of 1 V, 2 V, and 3 V. The removal rates of humic acid are 71%, 76% and 82%, and the membrane water fluxes are 65%, 81% and 85%, respectively.

### Embodiment 4

As described in Embodiment 2, the only difference with the method used for organic wastewater degradation in Embodiment 1 is the organic wastewater solution that contained 10⁵ CFU/mL E. coli.

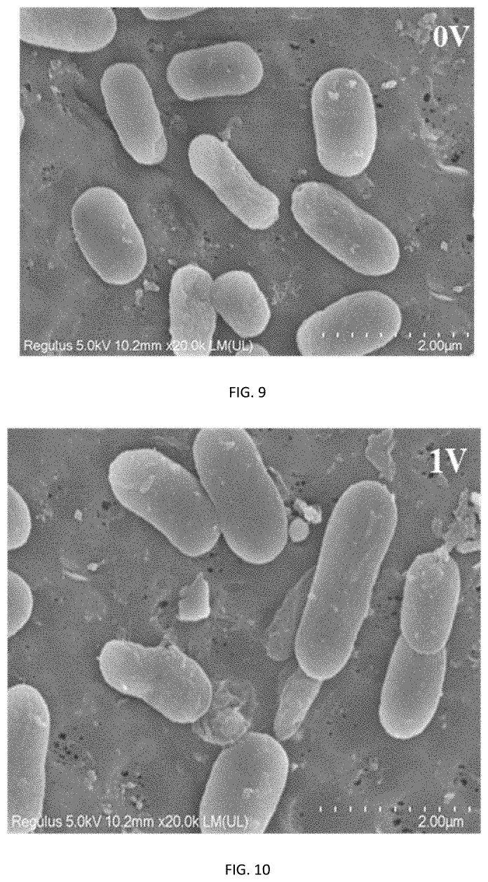

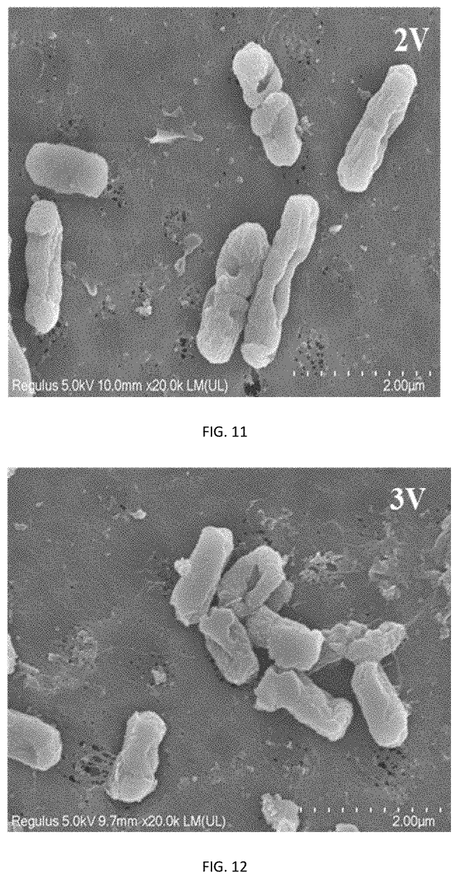

To test the quality of purified water after 30 min operation in this embodiment, the effect of pollutant removal is recorded under the stable voltages of 1 V, 2 V, and 3 V. The bacterial mortality of the effluent reaches 100% at all voltages, and the membrane water fluxes are 71%, 80% and 85%, respectively. As shown in FIG. 9-12, the E. coli cell rupture and death are detected. As voltage increases, the cell rupture declines. Thus, the conductive organic membrane coupled filtration system has an efficient bactericidal ability.

Contrasting Case 1

A common ultrafiltration system used for removal of organic wastewater consists of PVDF ultrafiltration membrane sold by sterlitech company as a conductive organic membrane. In this experiment, a voltage of 3 V is applied by the potentiostat to the system and filtered water is collected after 30 min. The removal rate of methyl orange in the test organic wastewater treatment is estimated to 36%, and the water flux of the membrane is 55%.

Contrasting Case 2

As described in Embodiment 2, the difference from the method used to degrade organic wastewater in Embodiment 1 is the applied voltage by the potentiostat, which is set to 0 V. The filtered water under these conditions is then collected after 30 min to test the efficiency of the organic wastewater treatment. The removal rate of methyl orange under these conditions is less than 20%, and water flux of the membrane is 60%.

Contrasting Case 3

As described in Embodiment 2, the difference from the method used to degrade the organic wastewater in Embodiment 1 is the applied voltage by the potentiostat, which is set to 0 V. The filtered water is collected after 30 min to test the efficiency of organic wastewater treatment. The removal rate of humic acid, in this case, is recorded as 65%, and the water flux of the membrane is 40%.

What is claimed is:

1. The novel conductive organic membrane-coupled filtration system comprises a connected water pump and a reactor, upper end of the reactor contains a water inlet and the lower end is provided with a water outlet, a counter electrode and a membrane electrode are fixed on the reactor between the water inlet and water outlet, the counter electrode and membrane electrode constitute a two-electrode system connected to an external potentiostat through metal wires, the membrane electrode is a carbon-based PVDF membrane.

2. The conductive organic membrane-coupled filtration system described by claim 1 comprises a metal wire made of titanium.

3. The conductive organic membrane-coupled filtration system described by claim 1 comprises a counter electrode and a membrane electrode embedded in the electrode slot of the reactor and fixed by waterproof glue, Vaseline, and silica gel gasket.

4. The conductive organic membrane-coupled filtration system described by claim 1 comprises a counter electrode located directly above the membrane electrode.

5. The conductive organic membrane-coupled filtration system described by claim 1 comprises a vertical distance between the membrane electrode and the counter electrode set to 1-3 cm.

6. The conductive organic membrane-coupled filtration system described by claim 1 comprises a counter electrode made of platinum mesh, titanium mesh, or stainless steel mesh.

7. The conductive organic membrane-coupled filtration system described by claim 1 comprises a potentiostat with output voltages ranging from 0 to 3 V.

8. The conductive organic membrane-coupled filtration system described by claim 1 comprises a membrane electrode prepared by coating the PVDF casting solution on pretreated dry carbon fiber by scraping the membrane to yield a coating thickness of 300-400 μm, the modified carbon fiber is then left to stand in the air for 1-5 min followed by immersion in deionized water overnight to form the PVDF coating substrate membrane, after vacuum drying, a smooth and uniform carbon-based-PVDF membrane is obtained by the phase inversion method.

9. The conductive organic membrane-coupled filtration system described by claim 8 comprises a carbon fiber made of polyacrylonitrile.

10. The conductive organic membrane-coupled filtration system described by claim 8 states that the carbon fiber is pretreated by ultrasounds in acetone, ethanol, and deionized water solution respectively for 60-80 min to remove organic matter and other impurities attached to it followed by drying at 50-80° C. for 4-5 hours.

11. The conductive organic membrane-coupled filtration system described by claim 8 states that the PVDF casting solution is prepared by dissolving PVDF powder and PVP in DMF under magnetic stirring for 10-12 hours, the mixture is then vacuum degassed at 50-80° C. for 3-5 hours to yield a PVDF casting solution. The mass ratio of PVDF powder to those of PVP and DMF is 12:2:86.

12. The conductive organic membrane-coupled filtration system described in claim 8 states that the vacuum drying conditions are set to 50-80° C. and 50-70 min.

13. The conductive organic membrane-coupled filtration system described by claim 8 states that the phase conversion method is used by first coating the PVDF casting solution onto the PVDF coated base membrane by scraping, the resulting base membrane is then fixed on the glass plate, and the coating thickness is adjusted to 200-400 μm, after standing in the air for 1^{˜}3 min, the glass plate is slowly immersed in 25-28° C. constant temperature deionized water, this process transforms the gel structure into a three-dimensional macromolecular network, which is cured after phase transformation.

14. A method for degrading organic wastewater by the conductive organic membrane-coupled filtration system described by claim 1 comprises the following steps:
a reactor is used to pretreat the pure water passing through the system for 20-30 minutes to stabilize the membrane electrode, after pretreatment, a stable voltage is applied by the potentiostat to the counter electrode and membrane electrode, the organic wastewater is then continuously pumped into the reactor to yield purified wastewater flowing naturally out of the outlet.

15. The degradation method of organic wastewater described by claim 14 states that organic wastewater passing through the counter electrode and membrane electrode flows at the rate of 3-5 mL/min.

16. The degradation method of organic wastewater described by claim 14 states that organic wastewater is made by water containing methyl orange or humic acid.
